(19) United States
(12) Patent Application Publication
(10) Pub. No.: US 2018/0134525 A1
(43) Pub. Date: May 17, 2018

(54) Four Cable Operated Scissors

(71) Applicant: Nemag B.V., Zierikzee (NL)

(72) Inventors: Willem Albert de Kluijver, Zierikzee (NL); Michel Corbeau, Zierikzee (NL)

(21) Appl. No.: 15/568,289

(22) PCT Filed: May 2, 2016
(86) PCT No.: PCT/NL2016/050314

§ 371 Date: Oct. 20, 2017

(30) Foreign Application Priority Data
May 1, 2015 (NL) 2014756

(51) Int. Cl. B66C 3/12; B66C 3/02

(52) U.S. Cl. CPC B66C 3/12; E02F 3/47; B66C 3/02

(57) ABSTRACT

Four cable operated scissors grab (1), comprising a pair of scissor levers (2a, 2b) that are connected via a pivot joint to pivot about a pivoting axis (4), which scissor levers each include a grab shell (5a, 5b) and a hoist cable connection (6a, 6b) situated on a first side of the lever with respect to the pivot joint, and a closing cable connection (8a, 8b) situated on a second side of the lever that is opposite with respect to the pivot joint, so that in use a dedicated hoisting cable is fastened to each lever on the first side of the lever, and a dedicated closing cable is fastened to each lever at the second side of the lever. The scissor levers each include a sheave (12a, 12b) on the second side of the lever, and said sheaves are each arranged as a first and final closing sheave, so that in use each of the two closing cables extend in a single pass from a closing cable connection on the second side of one lever via the closing sheave on the second side of the other lever to depart from the grab and continue upward to a crane carrying the grab.

The invention relates to a four cable operated scissors grab. Such scissors grabs are well known in the art and are commonly used for handling of bulk materials, such as coal or iron ore. A commercially successful four cable operated scissors grab is disclosed in U.S. Pat. No. 4,538,848 and comprises a pair of scissor levers that are connected via a pivot joint to pivot about a pivoting axis, which scissor levers each include a grab shell and a hoist cable connection situated on a first side of the lever with respect to the pivot joint, and a closing cable connection situated on a second side of the lever that is opposite with respect to the pivot joint, so that in use a dedicated hoisting cable is fastened to each lever on the first side of the lever, and a dedicated closing cable is fastened to each lever at the second side of the lever. One or both scissor levers may include a closing sheave on the second side of the lever.

Compared to other types of grabs, for example clamshell grabs that include a triangular frame with pivoting supporting arms, scissor grabs have a number of operational characteristics that are particularly favorable for bulk handling. For example, the scissored configuration allows a relatively low center of gravity, a broad spread of the grab shells, a horizontal closing path of the bottom edges of the shells, flexible chain connections that prevent damage to cargo holds, and a relatively low number of pivot connections that require maintenance. However, the construction of the scissors grab is relatively expensive compared to a clamshell grab.

The present invention aims to improve a scissors grab, in particular with respect to the efficiency of the grab construction and/or its operational characteristics.

Thereto the invention provides for a four cable operated scissors grab, comprising a pair of scissor levers that are connected via a pivot joint to pivot about a pivoting axis, which scissor levers each include a grab shell and a hoist cable connection situated on a first side of the lever with respect to the pivot joint, and a closing cable connection situated on a second side of the lever that is opposite with respect to the pivot joint, so that in use a dedicated hoisting cable is fastened to each lever on the first side of the lever, and a dedicated closing cable is fastened to each lever at the second side of the lever, wherein the scissor levers each include a sheave on the second side of the lever, wherein said sheaves are each arranged as a first and final closing sheave for the closing cable. In use each of the two closing cables may extend in a single pass from a closing cable connection on the second side of one lever via the closing sheave on the second side of the other lever, and may then depart from the grab and continue upward to a crane carrying the grab.

By arranging each sheave as a first and final closing sheave as claimed, the construction of the grab can be significantly simplified. In particular, each scissor lever needs to include only one closing sheave, and may be free of further closing sheaves that guide the closing cable. This increases the efficiency of the grab and improves operational characteristics as apart from any rotational cable connections, the grab needs to only include maintenance at rotational connections at the final closing sheaves and at the pivot joint. As the two closing cables extend in a single pass from the closing cable connection via the closing sheaves to depart from the grab, the stroke of the closing cables needed to adjust the grab between a closed position and a fully opened position may be significantly shortened. This improves operational characteristics, as the grab may be used more efficiently due to reduced opening and closing times.

It should be noted that as used in the context of this patent specification, a closing sheave is meant to be a sheave which, in operation, is continuously in contact with the closing cable, as opposed to e.g. a push-up sheave or guide which is only during part of an opening and closing cycle in contact with the closing cable. Further, a closing sheave as used in the context of this patent specification is meant to be a sheave which guides the closing cable about at least 60 degrees, preferably at least 85 or 90 degrees its circumference. Further, a closing sheave as used in the context of this patent specification is preferably meant to be a sheave which is rotatably connected to the lever.

It should further be noted that as used in the context of this patent specification, a cable is meant to be a flexible, tension loadable connection element such as a wire, cable or chain, in particular made of steel.

By situating each final closing sheave at or near an end of the second side of the lever that faces away from the pivot joint, the closing momentum can be maximized.

By having the first and second sides of the lever extend continuously at the pivot joint, the construction of the levers can be relatively simple. The scissor levers may include plates, for example steel plates, that extend from the grab shell to the final closing sheave as continuous sections.

By constructing each scissor lever to include two lever plates that extend in interspaced relation, a relatively stiff, strong and light weight lever may be obtained. By arranging the scissor levers to include stiffening profiles on the first sides that extend parallel to the pivoting axis, the construction may be stiff, yet of relatively low weight. The profiles may be embodied as pipes, tubes or beams having open or closed cross section.

The stiffening profiles may be arranged to form a cross stiffener that continues from one side of the shell to another. This significantly adds to providing an efficient, light weight yet stiff construction. The profiles may e.g. extend between the lever plates and between the lever plates and the sides of the grab shells.

By embodying the scissor levers of the pair to be substantially identical, and by connecting them via the pivot joint in a mirrored arrangement, constructional efficiency may be increased further as the number of different parts is reduced.

By situating the closing cable connection at or near an end of the second lever that faces away from the pivot joint, closing momentum may be maximized. Advantageously, the closing cable connection may be located at or near a final closing sheave.

The final closing sheaves may each be provided with a cable guide that covers part of the circumference of the final closing sheave to hold the closing cable on the final closing sheave, e.g. when the closing cable is slack. In particular, the cable guide may guide the closing cable along the circumference to a point of departure from the final closing sheave and from the grab.

By disposing the cable guide movably relative to the final closing sheave, it may be achieved that the cable guide covers the relevant part of the circumference of the final closing sheave independent of the position or orientation of the grab. The cable guide is preferably rotatably disposed relative to the final closing sheave.

The cable guide may include the closing cable connection so as to allow movement relative to the final closing sheave. This way, the end of the closing cable may be used to move, in particular rotate, the cable guide to a part of the circumference of the final closing sheave that needs to be covered to keep the closing cable on the circumference. Preferably, the closing cable connection is rotatably disposed relatively to the lever to prevent wear. Advantageously, the closing cable connection and the cable guide may be integrated to form a closing cable connector with integral cable guide. Such a cable connector with integral cable guide may comprise a carrier, which in use may be rotatably connected to a grab, in particular to a second part of the lever. The carrier may include a first portion to which the cable connects that extends from a rotational joint in a first direction, and may further include a second portion that is provided with a cable guide that extends from the rotational joint in a second, opposite direction, and that covers part of the circumference of a sheave of the grab to hold the cable on the circumference of the sheave. Such a cable connector may be used with any type of grab, and is not limited to use with the grab as claimed, but may also be used in other types of scissor grabs or even other types of grabs.

Advantageously, the rotational joint of the carrier may be carried on the pivot axle of the final closing sheave. This further simplifies construction. The final closing sheave and the carrier may be arranged to be independently rotatable relative to the lever.

The scissor levers may be arranged to pivot about the pivot axis between a closed position of the grab in which side and bottom edges of the shells are adjacent each other and the shells cooperate to form a bucket to hold material to be handled, and a fully opened position of the grab in which the side and bottom edges are spaced apart and define a maximum opening there between through which material to handled can pass.

The grab may be arranged such that, when the grab moves from the closed position to the fully opened position, a plane through the pivot axis and the side and bottom edges of the grab shall has an angular displacement about the pivot axis that is included in the range 50-70 degrees. In more simplified wording, the grab shells may each have a maximum opening angle α that lies between 50 and 70 degrees. In particular, the maximum opening angle α of each shell is at least 55 degrees. Surprisingly, it has been found that such limited angular displacement or limited maximum opening angle α need not significantly influence the operational efficiency of the grab, while it e.g. facilitates the construction of a light weight, stiff and efficient grab because it allows for the provision of stiffening profiles as discussed above.

The grab structure as claimed may include a set of two hoisting cables that are connected to the hoisting cable connections. The grab structure as claimed may alternatively or in addition include a set of two closing cables that are connected to the closing cable connections.

The closing cables may be interconnected via a connecting piece. Such connecting piece may be stiff, such as a yoke, or flexible, such as a chain or rope. Such connecting piece may be affixed to the closing cables near the grab to move along with the cables on the opening and closing stroke of the grab. Such connecting piece may in combination with the arrangement of the sheaves as first and final closing sheaves be useful to enhance the closing force. In addition it may assists to provide a correct fleet angle of the closing cable with respect of the sheaves of the crane carrying the grab. Such a connecting piece may also advantageously be provided on the hoisting cables near the grab.

The invention further relates to a four cable operated scissors grab, comprising a pair of scissor levers that are pivotably connected via a pivot joint, which scissor levers each include a grab shell and a hoist cable connection situated on a first side of the lever with respect to the pivot joint, and a closing cable connection situated on a second side of the lever that is opposite with respect to the pivot joint, so that in use a dedicated hoisting cable is fastened to each lever on the first side of the lever, and a dedicated closing cable is fastened to each lever at the second side of the lever, in which the scissor the levers are arranged to pivot about the pivot axis between a closed position of the grab in which side and bottom edges of the shells are adjacent each other and the shells cooperate to form a bucket that can hold material to be handled, and a fully opened position of the grab in which the side and bottom edges are spaced apart and define a maximum opening there between through which material to be handled can pass, wherein when the grab moves from the closed position to the fully opened open position, a plane through the pivot axis and the side and bottom edges of each grab shell has an angular displacement about the pivot axis that is included in the range of 50-70 degrees, and in particular is at least 55 degrees, and in particular is no more than 65 degrees. In more simplified wording, the grab shells may each have a maximum opening angle α that lies between 50 and 70 degrees. In particular, the maximum opening angle α of each shell is at least 55 degrees. Surprisingly, it has been found that such limited angular displacement or limited maximum opening angle α need not significantly influence the operational efficiency of the grab, while it e.g. facilitates the construction of a light weight, stiff and efficient grab because it allows for the provision of stiffening profiles as discussed above.

It should be noted that the technical features described above may each on its own be embodied in a grab, in particular a scissors grab, i.e. isolated from the context in which it is described, separate from other features or in combination with only a number of features described in the context in which it is disclosed. Each of these features may further be combined with any other feature disclosed, in any combination.

The invention will be further elucidated on the basis of non-limitative exemplary embodiments represented in the drawings. In the drawings:

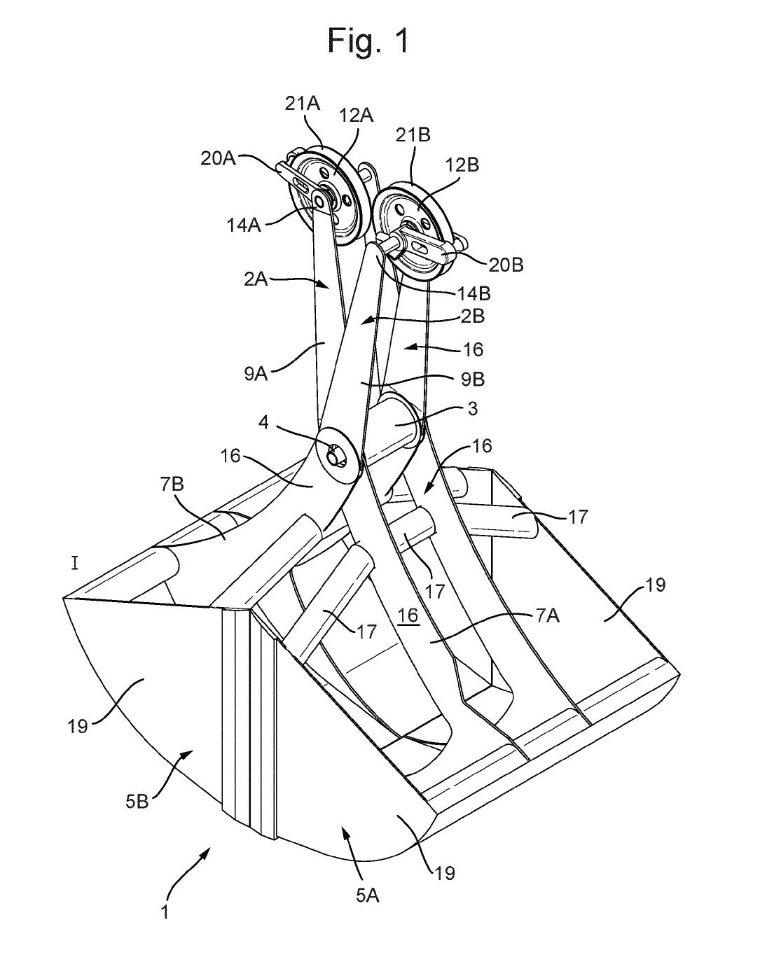

FIG. 1 shows a schematic perspective view of a first embodiment of a grab in accordance with the invention in a closed position;

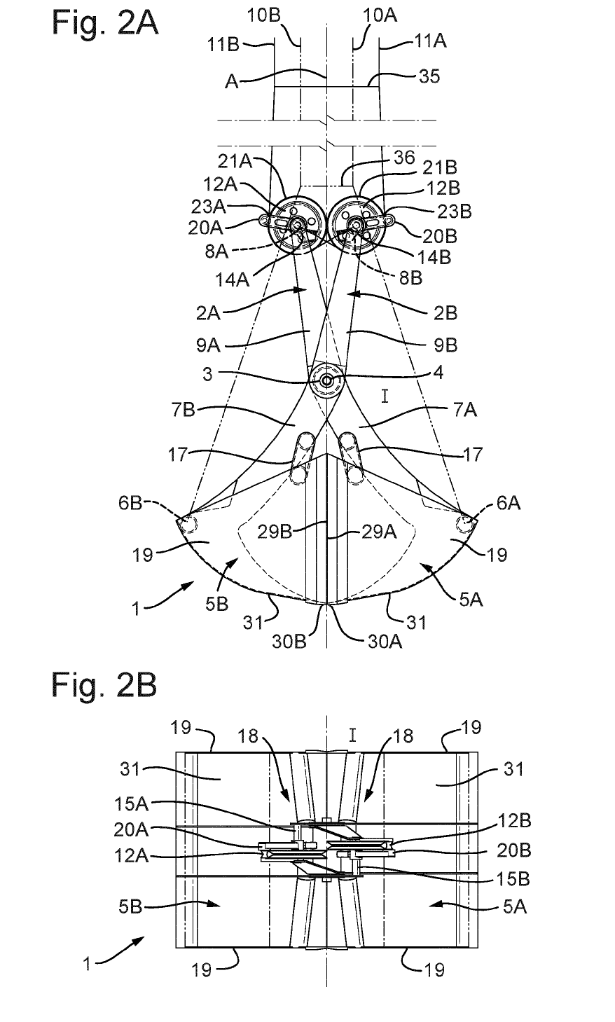

FIG. 2A shows a schematic front view of the grab of FIG. 1 in closed position;

FIG. 2B shows a schematic top view of the grab of FIG. 1 in closed position;

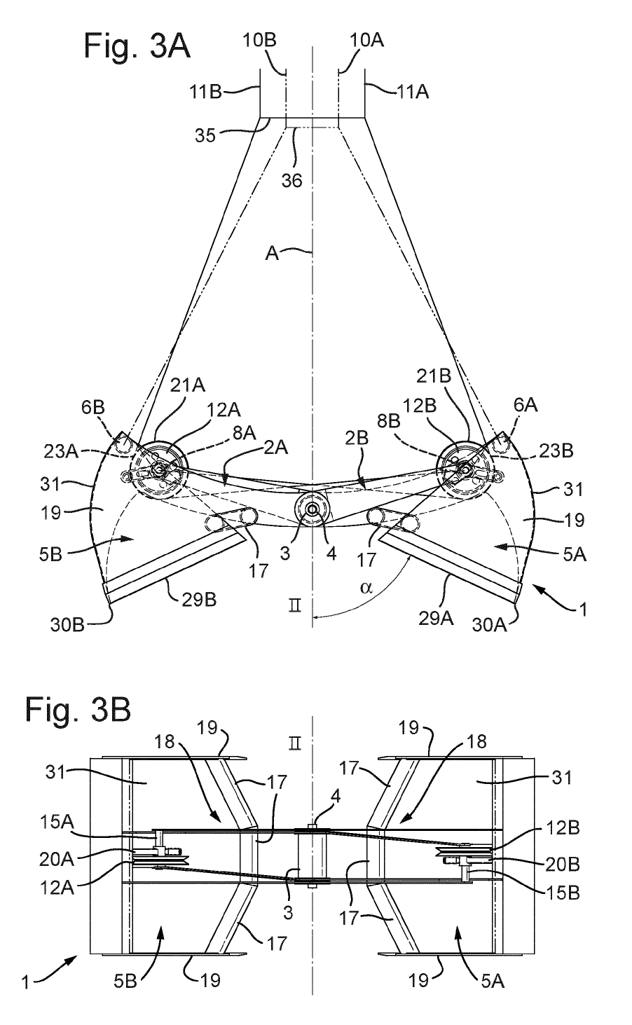

FIG. 3A shows a schematic front view of the grab of FIG. 1 in fully opened position;

FIG. 3B shows a schematic top view of the grab of FIG. 1 in fully opened position;

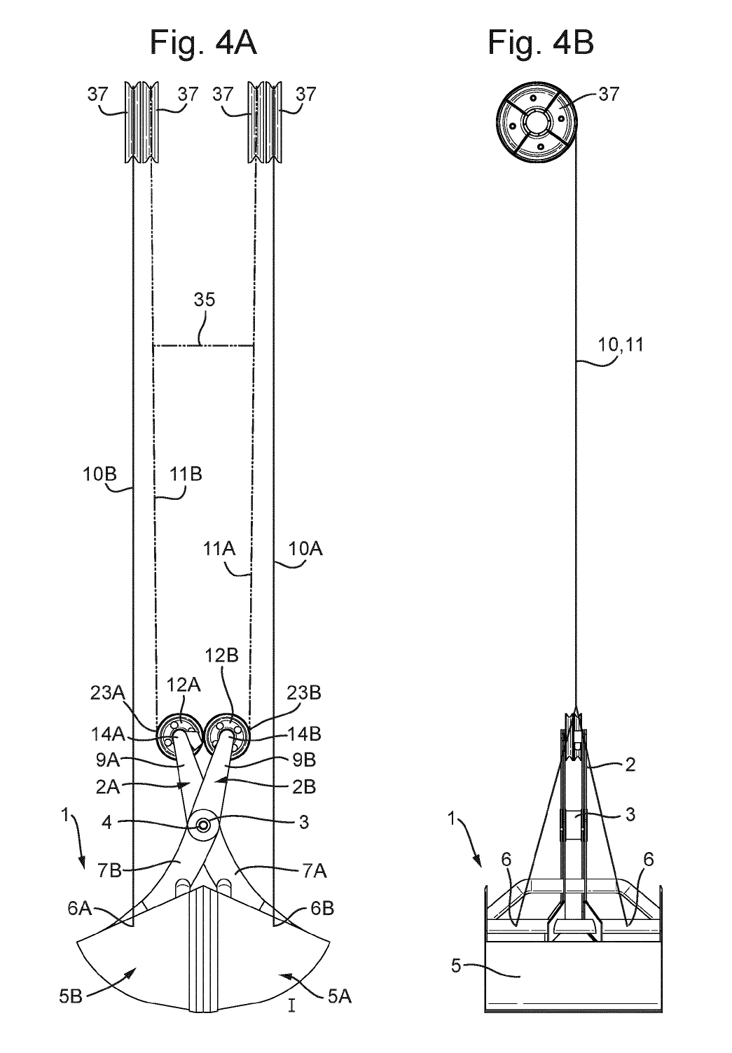

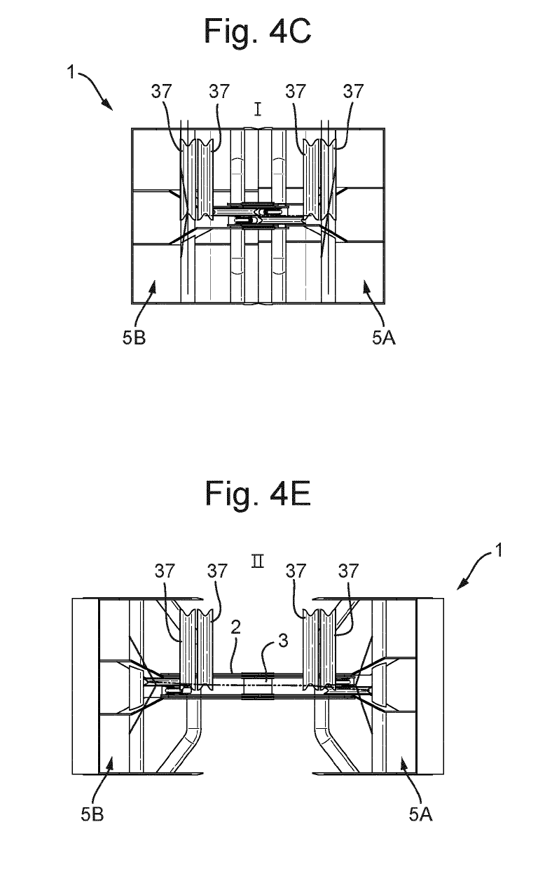

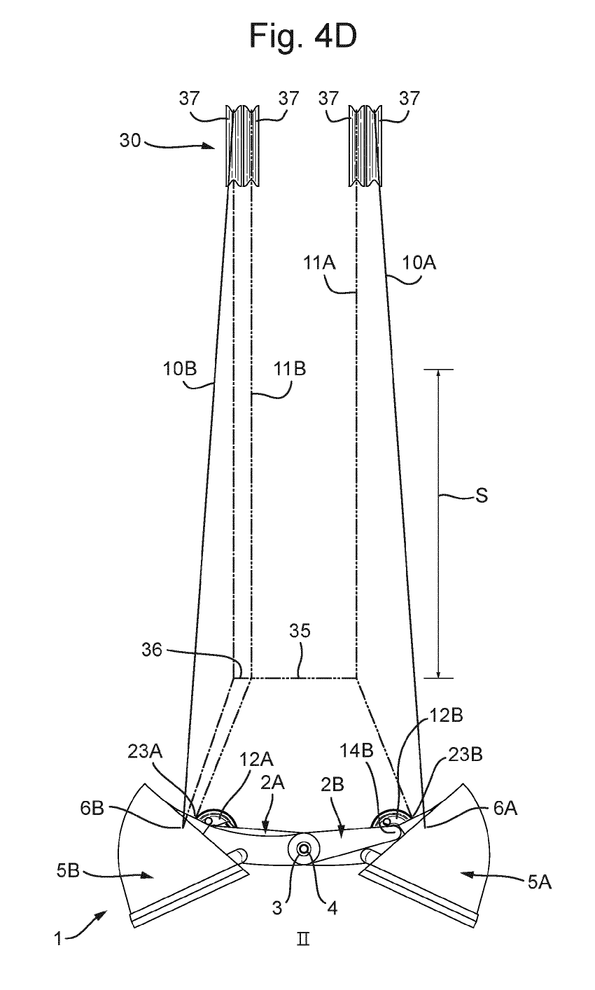

FIG. 4A shows a schematic front view of the grab of FIG. 1 in closed position attached to a crane;

FIG. 4B shows a schematic side view of the grab of FIG. 4A;

FIG. 4C shows a schematic top view of the grab of FIG. 4A;

FIG. 4D shows a schematic front view of the grab of FIG. 4A in fully opened position;

FIG. 4E shows a schematic top view of the grab of FIG. 4D;

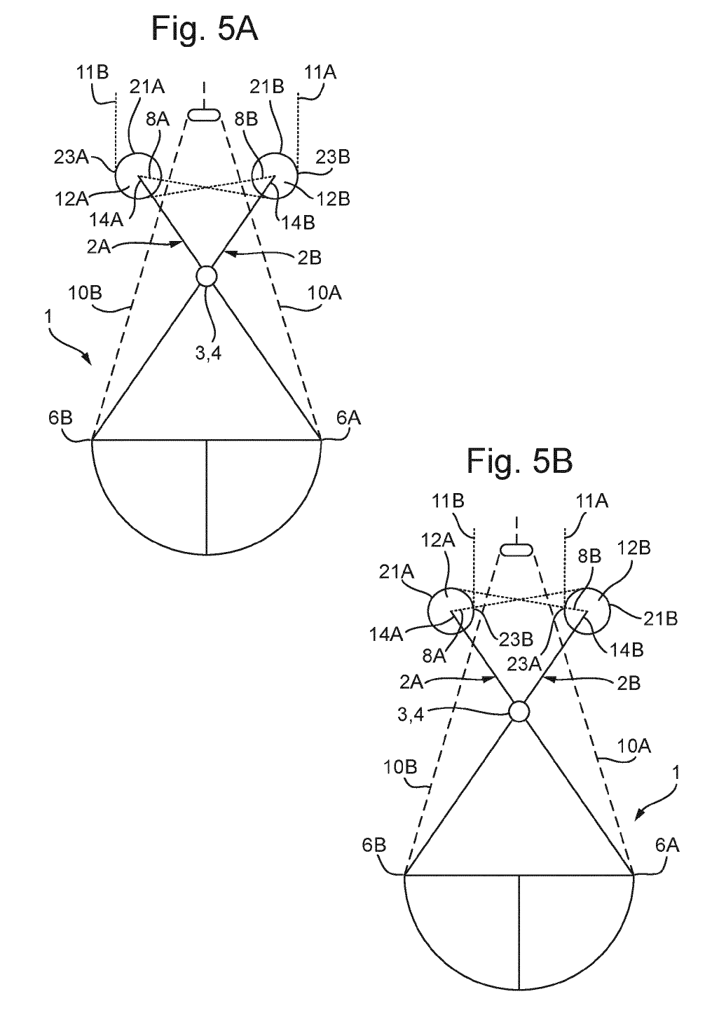

FIG. 5A-B show two schematic front views of the grab according to the invention with the closing cables on the outside and inside of the final closing sheaves respectively;

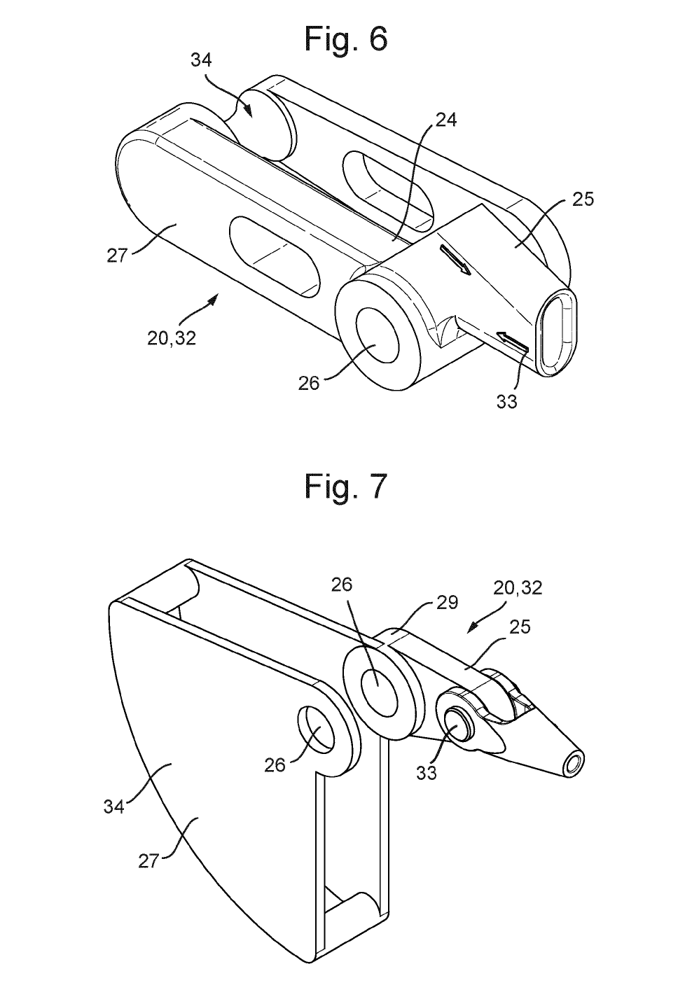

FIG. 6 shows schematic perspective view of a first embodiment of a closing cable connector with integral cable guide;

FIG. 7 shows a second embodiment of a closing cable connector with integral cable guide;

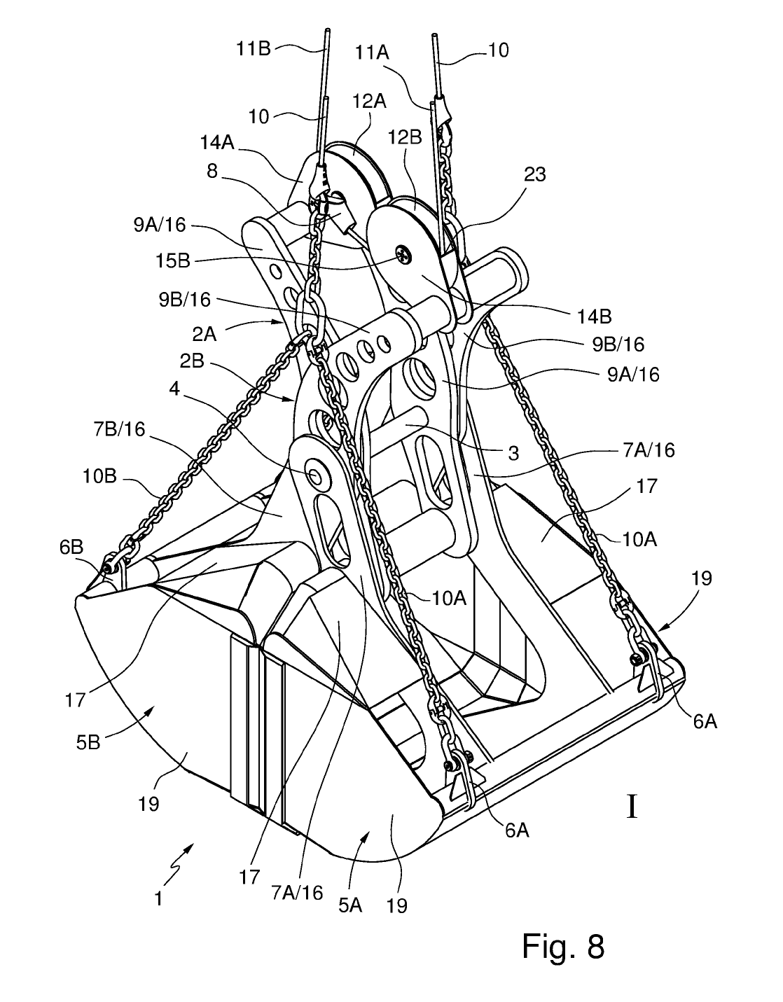

FIG. 8 shows a schematic perspective view of a further embodiment of a grab in accordance with the invention in a closed position;

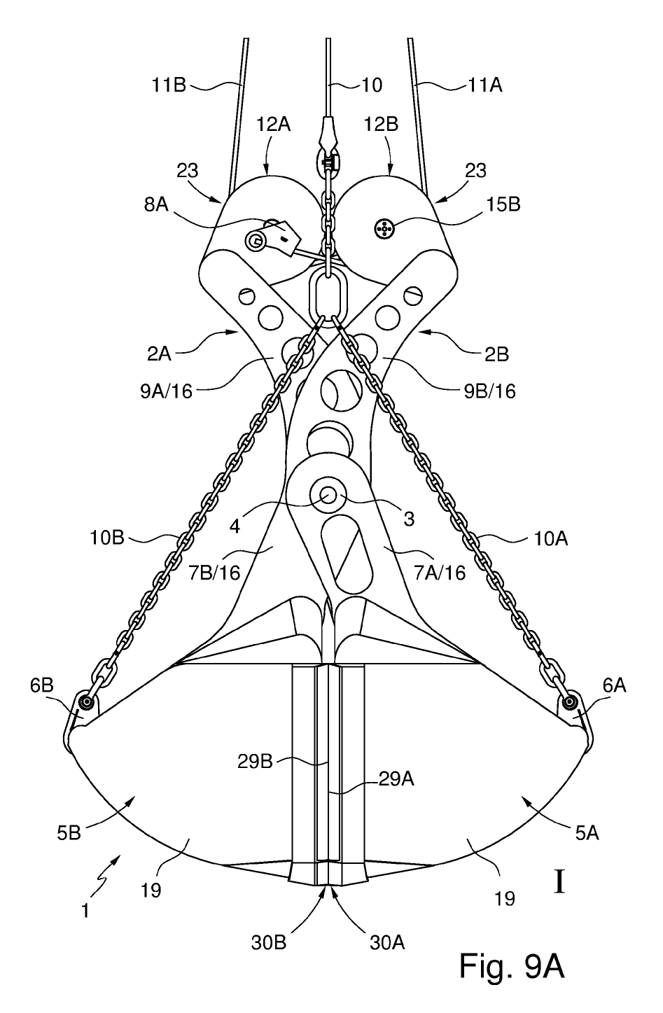

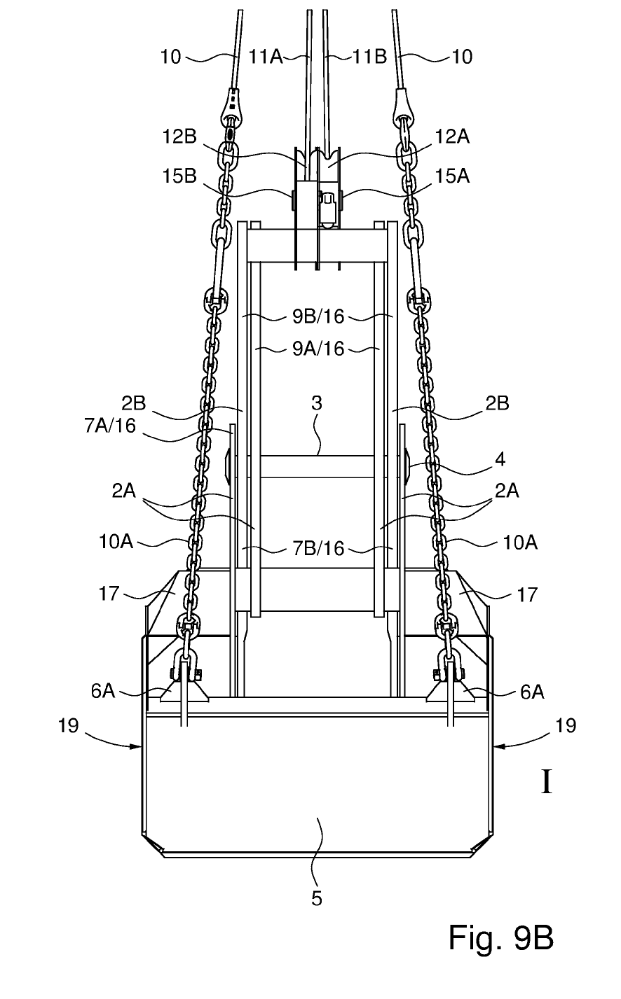

FIG. 9A shows a schematic front view of the grab of FIG. 8;

FIG. 9B shows a schematic side view of the grab of FIG. 8;

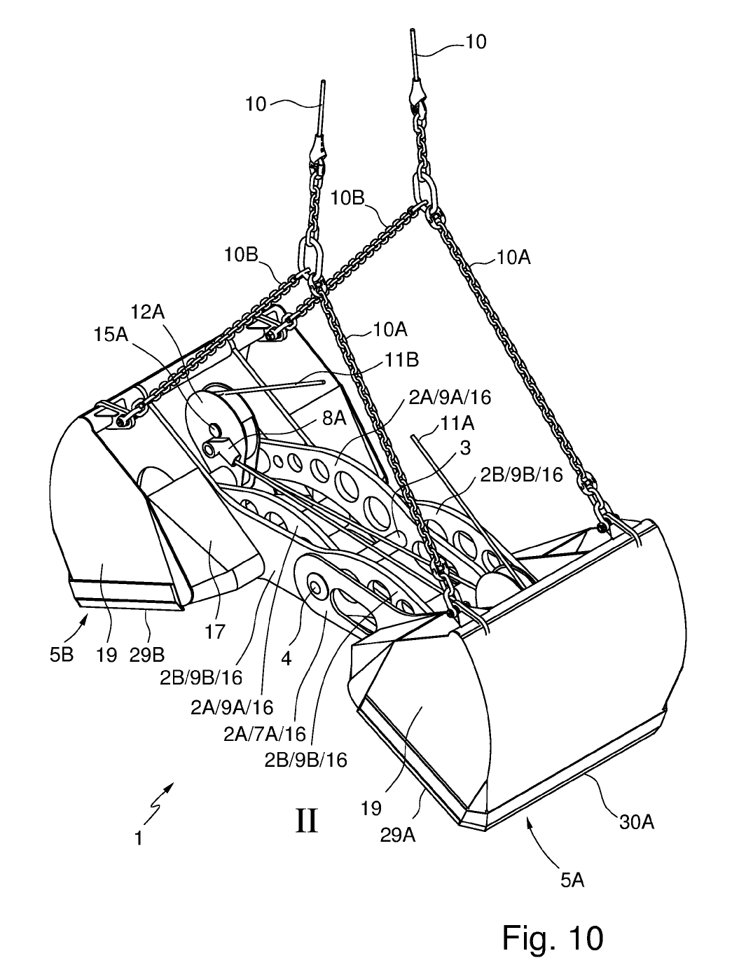

FIG. 10 shows a schematic perspective view of the grab of FIG. 8 in fully opened position;

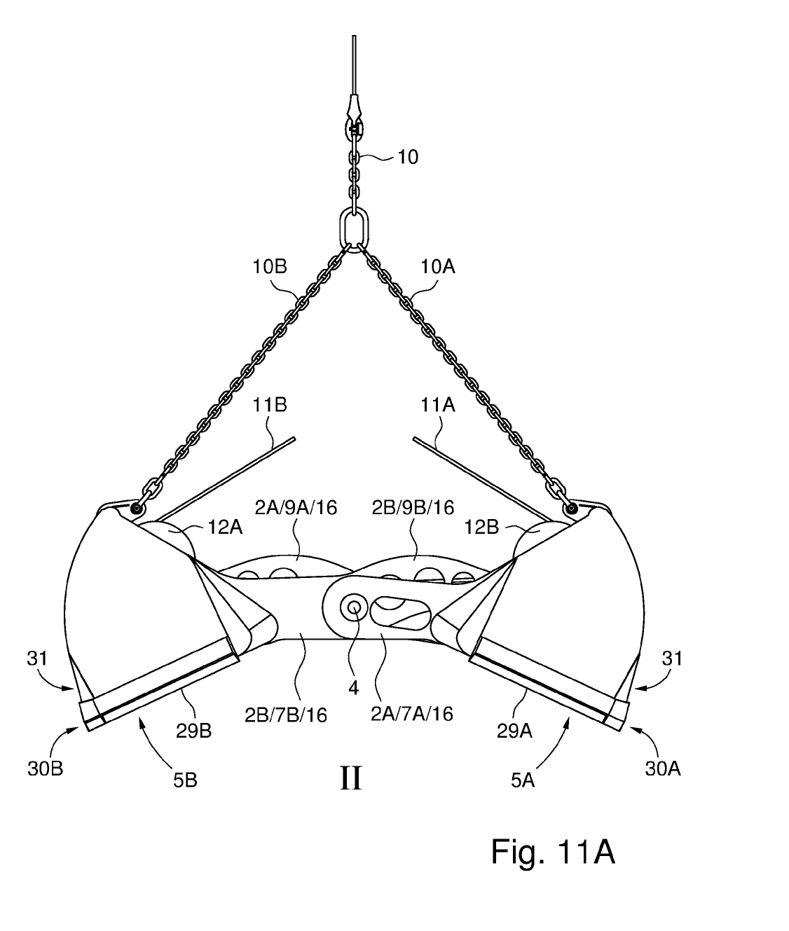

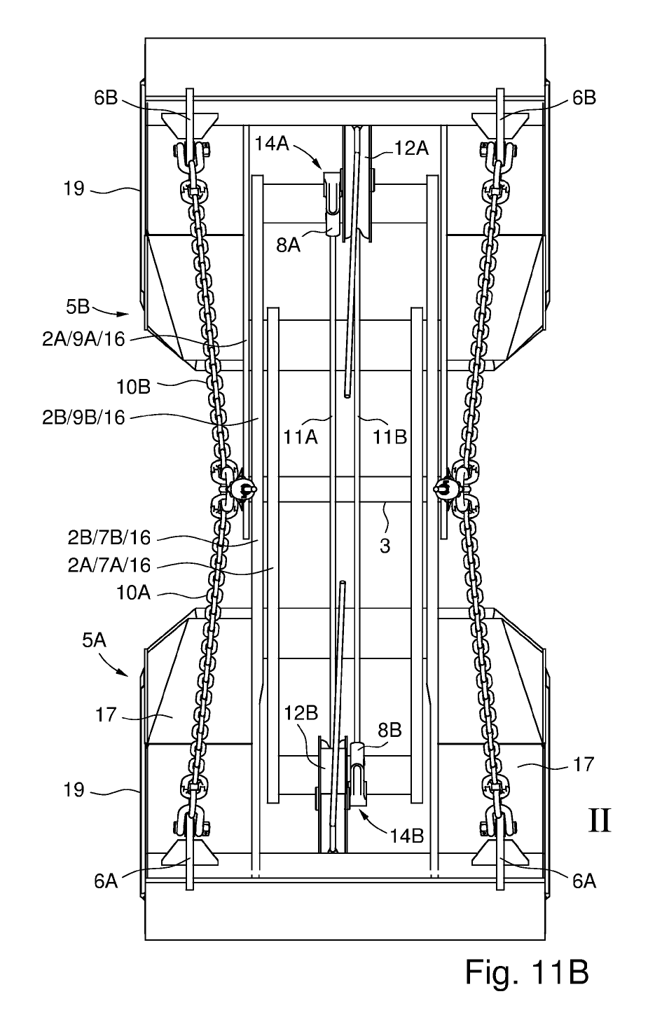

FIG. 11A shows a schematic front view of the grab of FIG. 10,

FIG. 11B shows a schematic top view of the grab of FIG. 10, and

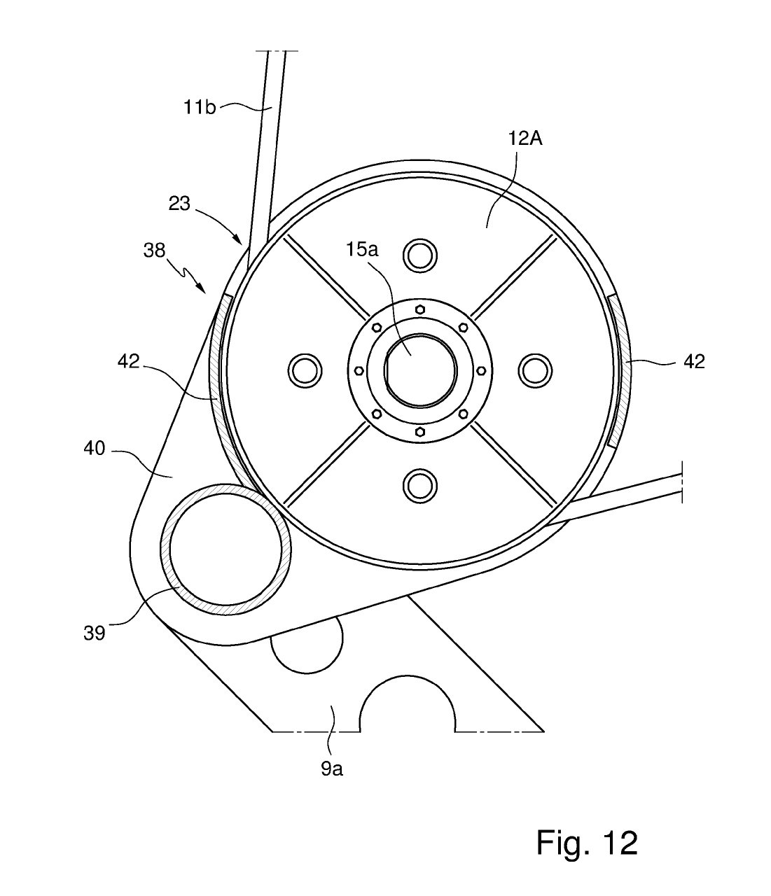

FIG. 12 shows a schematic cross section of a gaff section of the grab of FIG. 8.

It should be noted that the figures are merely schematic representations of preferred embodiments of the invention. In the figures, identical or corresponding parts are represented with the same reference numerals.

Referring to FIGS. 1-3, a four cable operated scissors grab 1 is shown. The grab 1 comprises a pair of scissor levers 2a, 2b. The scissor levers 2a, 2b are connected via a conventional pivot joint 3 and are arranged to pivot about a pivoting axis 4 central to the pivot joint.

The scissor levers 2a, 2b each include a grab shell 5a, 5b, and a hoist cable connection 6a, 6b situated on a first side 7a, 7b of the first and second levers 2a, 2b respectively. The scissor levers 2a, 2b of the grab 1 further include a closing cable connection 8a, 8b on a second side 9a, 9b of the first and second levers 2a, 2b respectively. As may be seen best in FIGS. 2A and 3A, in use a dedicated hoisting cable 10a, 10b is fastened to the first side 7a, 7b of the levers 2a, 2b respectively, and a dedicated closing cable 11a, 11b is fastened to the second side 9a, 9b of the first and second levers 2a, 2b respectively. The scissor levers 2a, 2b each include a sheave on the second side 9a, 9b of the levers 2a, 2b respectively, which sheaves are arranged as first and final closing sheave 12a, 12b for the closing cable 11a, lib.

In use each of the two closing cables 11a, 11b extend in the single pass from a respective closing cable connection 8a, 8b on the second side 9a, 9b of one lever 2a, 2b via the closing sheave 12a, 12b on the second side 9a, 9b of the other lever 2a, 2b. The closing cables 11a, 11b depart the grab 1, and continue upward to a crane 13 carrying the grab 1.

Each final closing sheave 12a, 12b is situated at an end 14a, 14b of the second side 9a, 9b of the respective lever 2a, 2b that faces away from the pivot joint 3. The scissor levers 2a, 2b each include only one closing sheave, which is embodied as a final closing sheave 12a, 12b. No further or auxiliary closing sheaves are present. The grab 1 includes rotational connections at only the two final closing sheaves 12a, 12b and at the pivot joint 3.

For each scissor lever 2a, 2b the first sides 7a, 7b and second sides 9a, 9b of the levers 2a, 2b extend in the same plane. The levers 2a, 2b each extend continuously at the pivot joint. The levers 2a, 2b each include two steel lever plates 16 that continuously extend with interspace from each other from the grab shell 5a, 5b respectively to the final closing sheave 12a, 12b.

The final closing sheaves 12a, 12b are provided on the second sides 9a, 9b of the levers 2a, 2b respectively via rotational connections 15a, 15b. The rotational connections are formed by pivot axles 28 on which the final closing sheaves 12a, 12b are bearing mounted.

The scissor levers 2a, 2b each include stiffening profiles 17 on the first sides 7a, 7b that extend parallel to the pivoting axis 4. The profiles 17 are embodied by sections that extend between the lever plates 16 and between the lever plates 16 and the sides 19 of the grab shells 5a, 5b to form a cross stiffener that continues from one side of the shell to another. The profiles extend with interspace along the bottom 31 of the grab shells 5a, 5b.

The scissor levers 2a, 2b are substantially identical and are connected via the pivot joint 3 in mirrored arrangement, so that an symmetrical construction is achieved.

The closing cable connection 8a, 8b respectively is situated at the end 14a, 14b of the second side 9a, 9b of the respective first and second levers 2a, 2b. As shall be discussed more in detail with respect to FIG. 6, the final closing sheaves 12a, 12b are each provided with a cable guide 20a, 20b that covers part of the circumference 21a, 21b of the final closing sheaves 12a, 12b to hold the closing cable 10a, 10b on the final closing sheave 12a, 12b. This is particularly useful when during operating, the closing cable becomes slack. The cable guide 20a, 20b is rotatably disposed relative to the final closing sheave 12a, 12b. The cable guide 20a, 20b includes the closing cable connection 8a, 8b to allow movement of the cable guide 20a, 20b relative to the final closing sheave 12a, 12b during operation. The closing cable connection 8a, 8b is rotatably disposed relative to the lever 2a, 2b. In this example the closing cable connection 8a, 8b and the cable guide 20a, 20b are integrated and form a closing cable connector with integral cable guide 32. This shall be discussed more in detail further on with respect to FIGS. 6 and 7.

The scissor levers 2a, 2b are arranged to pivot about the pivot axis 4 between a closed position I of the grab 1 in which side edges 29a, 29b and bottom edges 30a, 30b of the shells 5a, 5b are adjacent each other and the shells cooperate to form a bucket that can hold material to be handled, and a fully opened position II of the grab 1. In the fully opened position II of the grab 1, the side edges 29a, 29b and bottom edges 30a, 30b of the shells are spaced apart and define a maximum opening there between through which material to be handled can pass. The fully opened position II is shown in FIGS. 3a, 3b, 4d, 4e. When the grab 1 moves from the closed position I to the fully opened position II, a plane through the pivot axis and the side edges 29a, 29b and bottom edges 30a, 30b has an angular displacement a about the pivot axis 4 that is 65 degrees. The angle α as depicted is also known to the skilled person as the maximum opening angle of the shell of the grab.

In FIG. 4 it is shown that the grab is suspended from a crane 13, from which structure only its sheaves 37 are shown. The crane 13 includes a set of two hoisting cables 10a, 10b that are connected to the hoisting cable connections 6a, 6b. The grab 1 also includes a set of two closing cables 11a, 11b that are connected to the closing cable connections 8a, 8b.

The closing cables 11a, 11b are interconnected via a connecting piece 35, embodied as a chain. The connecting piece 35 is affixed to the closing cables 11a, 11b near the grab 1 to move along with the closing cables on the opening and closing stroke S of the grab 1 when it moves between the closed position I and the fully opened position II.

Also the hoisting cables 10a, 10b may be interconnected via a connecting piece 36. The connecting piece 36 may be separate, and can be affixed to the hoisting cables 10a, 10b near the grab 1 to move along with the opening cables on the opening and closing stroke S of the grab 1 when it moves between the closed position I and the fully opened position II. A portion of such a connecting piece 36 for the hoisting cables 10a, 10b is shown in FIG. 4d in dotted lines. Here it can be seen that a connecting piece may also assist to provide a correct fleet angle of the cable with respect of the sheaves 37 of the crane 13 carrying the grab 1.

When suspended from the crane 13 as shown in FIG. 4, the operation of the grab is a follows. The grab 1 can move from the closed position I to the fully opened position II under the influence of gravity when the closing cables 11a, 11b are reeled off. The crane 13 then 1 reels the closing cables 11a, 11b off via its sheaves to make an opening stroke S. The crane 13 winches the closing cables 11a, 11b back up on a closing stroke S to move the grab 1 from the fully opened position II to the closed position I. The crane 13 can lift the grab 1 without moving it between the closed and opened positions I, II by winching both the hoisting cables 10a, 10b and the closing cables 11a, 11b up via its sheaves 37, and can lower the grab 1 again by reeling the hoisting cables 10a, 10b and closing cables 11a, 11b off.

FIGS. 5A-B show two schematic front views of the grab according to the invention, to illustrate reeving of the closing cables 11a, 11b. FIG. 5a and FIG. 5b show alternative reeving patterns. In both patterns, each closing cable 11a, 11b extends only in a single reeve between its point of connection 8a, 8b on the lever 2a, 2b and the final closing sheave 12a, 12b, then extends around a part of the circumference of the final closing sheave 12a, 12b to a point of departure 23a, 23b on the circumference 21a, 21b of the final closing sheave 23a, 23b, to depart from the grab 1 and continue upward to the crane 13. In use, the closing cable 11a, 11b extends around about 90 degrees of the circumference of the final closing sheave 12a, 12b. No further or auxiliary closing sheaves 12a, 12b need be provided. As is illustrated in FIG. 5a and FIG. 5b, the point of departure 23a, 23b may be located on the outside or inside of the grab 1 respectively. When located on the inside, the closing cable 11a, 11b extends around about 270 degrees of the circumference of the final closing sheave 12a, 12b.

Due to the closing sheaves on the grab 1 being arranged as final closing sheaves 12a, 12b, the closing cables 11a, 11b in the closed position I of the grab 1 typically extend upward to the crane 13 spaced apart and mirrored from an upright center plane A of the grab 1 passing through or including the rotation axis of the grab. After leaving the final closing sheave 12a, 12b, the closing 11a, 11b cables extend to the crane 13 without passing over the center of the grab, and in particular without being guided back through the upright center plane A to the lever arm that carries its cable connection.

In FIG. 6, the closing cable connector with integral cable guide 32 is shown more in detail. It comprises a carrier 24 that is rotatably connected to the second side 9a, 9b of the first and second lever 2a, 2b respectively. The carrier 24 comprises a first portion 25 with a cable connecting part 33 to which the closing cable 10a, 10b connects, and that extends from a rotational joint 26 in a first direction. The carrier 24 further includes a second portion 25 that is provided with a cable guide part 34 and that extends from the rotational joint in a second, opposite direction. The rotational joint 26 of the carrier 24 is carried on the pivot axle 28 of the final closing sheave 12a, 12b, and is independently rotatable.

The cable guide part 34 covers a part of the circumference 21a, 21b of the final closing sheave 12a, 12b. During operation, it holds the closing cable 10a, 10b on the circumference 21a, 21b of the closing sheave 12a, 12b. In the embodiment of FIG. 6, the cable connector with integral guide 32 is embodied to only guide at the point on the circumference 21a, 21b. The closing cable connecting part 33 on the first portion 25 of the carrier 24 is embodied as a so called rope wedge socket.

In a second embodiment which is shown in FIG. 7, the cable guide part 34 is arranged to guide the closing cable about an arc section of the circumference 21a, 21b of the closing sheave 21a, 21b, e.g. about 90 degrees. In this embodiment, the cable connecting part 33 includes a cable pear.

Referring to FIGS. 8-12, a further embodiment of a grab 1 in accordance with the invention is shown. In this further embodiment, the second sides 9a, 9b of the scissor levers 2a, 2b are curved outwardly, and the final closing sheaves 12a, 12b are located in gaff sections 38a, 38b that form the ends 14a, 14b of the second sides 9a,9b of the scissor levers 2a, 2b. The gaff sections 38a, 38b include parallel planar gaff plates 40 that are non-rotatably affixed to a transverse stiffener, here embodied as a tube 39. The two parallel planar plates 40 of each gaff house a final closing sheave 12 between them. Each final closing sheave 12 is bearing mounted on an axle so as to form a rotational connection 15. The closing cable connections 8 are here formed by a conventional rope wedge socket that is rotatably carried a the gaff plate 40. Stationary cable guides 42 formed as a curved skirt extend along a part of the final closing sheave, as can be seen in FIG. 12. The gaff guides 42 are mounted with the base of the skirt on one of the gaff plates 40, and along their height extend transversely toward the facing gaff plate 40.

In this further embodiment, the grab 1 has the same basic structure and functionality as the grab 1 of the first embodiment. However, the scissor levers 2a, 2b are configured differently than in the first embodiment. In particular, the scissor levers are each built up of parallel planar plates that are interspaced by transverse stiff elements. One scissor lever 2b extends continuously at the pivot axis 4, while the other scissor 2a lever is interrupted at the pivot axis 4. An inner portion of the crossing lever 2a, i.e. the second side 9a, includes an extension 43 that extends beyond a transverse tube 44 to partially overlap with an outer portion of the crossing lever 2a, i.e. first side 7a, up to a transverse stiffener 45 that is arranged in parallel to the pivot tube. In this embodiment, the transverse stiffener is embodied as a tube. Also, the ends 14a, 14b of the scissor levers 2a, 2b comprise transverse stiffeners 39, here also embodied as tubes, that carry gaff sections 38. The gaff sections 38 are again arranged as parallel planar gaff plates 40. Such arrangement of the scissor levers as parallel planar plates interspaced by transverse stiffening elements allows for a lightweight, yet stiff construction, with e.g. a relatively light pivot joint 3. The invention therefore also relates to a four cable operated scissors grab, comprising a pair of scissor levers that are pivotably connected via a pivot joint, which scissor levers each include a grab shell and a hoist cable connection situated on a first side of the lever with respect to the pivot joint, and a closing cable connection situated on a second side of the lever that is opposite with respect to the pivot joint, so that in use a dedicated hoisting cable is fastened to each lever on the first side of the lever, and a dedicated closing cable is fastened to each lever at the second side of the lever, in which the scissor levers are arranged to pivot about the pivot axis between a closed position of the grab in which side and bottom edges of the shells are adjacent each other and the shells cooperate to form a bucket that can hold material to be handled, and a fully opened position of the grab in which the side and bottom edges are spaced apart and define a maximum opening there between through which material to be handled can pass, wherein the scissor levers are arranged as parallel planar plates interspaced by transverse stiff elements.

The invention is not limited to the exemplary embodiments represented here, but includes variations. For example, the configuration of the sheaves on the crane may vary. The invention may also be defined in terms of the cable arrangement on the grab, and may then not be limited to the presence of only a single, final closing sheave. Additional auxiliary closing sheaves may then be present. In such terms, the invention relates to a four cable operated scissors grab, comprising a pair of scissor levers that are connected via a pivot joint to pivot about a pivoting axis, which scissor levers each include a grab shell and a hoist cable connection situated on a first side of the lever with respect to the pivot joint, and a closing cable connection situated on a second side of the lever that is opposite with respect to the pivot joint, a dedicated hoisting cable being fastened to each lever on the first side of the lever, and a dedicated closing cable being fastened to each lever at the second side of the lever, wherein the scissor levers each include a sheave on the second side of the lever, characterized in that in use each of the two closing cables extends in a single pass from the closing cable connection on the second side of one lever via the closing sheave on the second side of the other lever to depart from the grab and to continue upward to a crane carrying the grab. Such variations shall be clear to the skilled person and are considered to fall within the scope of the invention as defined in the appended claims.
1 grab
2a, 2b lever
3 pivot joint
4 pivot axis
5a, 5b grab shell
6a, 6b hoist cable connection
7a, 7b first side of first respective second lever 2a, 2b
8a, 8b closing cable connection
9a, 9b second side of respective first and second lever
10a, 10b hoisting cable
11a, 11b closing cable
12a, 12b final closing sheave
13 crane
14a, 14b end of second part of respective first and second lever
15a, 15b rotational connection final closing sheave 12a, 12b
16 lever plate
17 stiffening profile
18 cross stiffener
19 side of shell
20a, 20b cable guide
21a, 21b circumference final closing sheave 12a, 12b
22 not used
23 point of departure
24 carrier
25 first portion carrier
26 rotational joint
27 second portion carrier
28 pivot axle
29a, 29b side edges
30a, 30b bottom edges
31 bottom of shell
32 cable connector with integral cable guide
33 cable connecting part
34 cable guide part
35 connecting piece closing cables
36 connecting piece hoisting cables
37 crane sheave
38 gaff section
39 tube
40 gaff plate
41 rope wedge socket
42 cable guide
43 extension
44 pivot tube
45 tube
I closed position grab
II fully opened position grab
α maximum opening angle grab shell
A center plane
S stroke

1. A four cable operated scissors grab, comprising a pair of scissor levers that are connected via a pivot joint to pivot about a pivoting axis, which scissor levers each include a grab shell and a hoist cable connection situated on a first side of the lever with respect to the pivot joint, and a closing cable connection situated on a second side of the lever that is opposite with respect to the pivot joint, so that in use a dedicated hoisting cable is fastened to each lever on the first side of the lever, and a dedicated closing cable is fastened to each lever at the second side of the lever, wherein the scissor levers each include a sheave on the second side of the lever, and wherein said sheaves are each arranged as a first and final closing sheave, so that in use each of the two closing cables extend in a single pass from the closing cable connection on the second side of one lever via the closing sheave on the second side of the other lever to depart from the grab and continue upward to a crane carrying the grab.

2. The grab of claim 1, in which each first and final closing sheave is situated at or near an end of the second side of the lever that faces away from the pivot joint.

3. The grab of claim 1, in which the scissor levers each include only one closing sheave.

4. The grab of claim 1, in which apart from any rotational cable connections, the grab includes rotational connections at only the two first and final closing sheaves and at the pivot joint.

5. The grab of claim 1, in which for each scissor lever, the first and second sides of the lever extend continuously at the pivot joint.

6. The grab of claim 1, in which the scissor levers each include two lever plates that extend in interspaced relation.

7. The grab of claim 1, in which the scissor levers each include stiffening profiles on the first sides extending parallel to the pivoting axis

8. The grab of claim 1, wherein stiffening profiles are arranged to form a cross stiffener that continues from one side of the shell to the other.

9. The grab of claim 1, in which the scissor levers of the pair are substantially identical and are connected via the pivot joint in a mirrored arrangement.

10. The grab of claim 1, in which the closing cable connection is situated at or near an end of the second lever that faces away from the pivot joint.

11. The grab of claim 1, in which the first and final closing sheaves are each provided with a cable guide that covers part of the circumference of the first and final closing sheave to hold the closing cable on the first and final closing sheave.

12. The grab of claim 11, in which the cable guide is movably disposed relative to the first and final closing sheave.

13. The grab of claim 12, in which the cable guide includes the closing cable connection so as to allow movement relative to the first and final closing sheave.

14. The grab of claim 1, in which the closing cable connection is rotatably disposed relative to lever.

15. The grab of claim 11, in which the closing cable connection and the cable guide are integrated.

16. The grab of claim 15, comprising a carrier, rotatably connected to the second side of the lever, which carrier includes a first portion to which the closing cable connects that extends from a rotational joint in a first direction, and that further includes a second portion that is provided with a cable guide that extends from the rotational joint in a second, opposite direction, and that covers part of the circumference of the first and final closing sheave to hold the closing cable on the first and final closing sheave.

17. The grab of claim 16, wherein the rotational joint of the carrier is carried on the pivot axle of the first and final closing sheave.

18. The grab of claim 1, in which the scissor levers are arranged to pivot about the pivot axis between a closed position of the grab in which side and bottom edges of the shells are adjacent each other and the shells cooperate to form a bucket that can hold material to be handled, and a fully opened position of the grab in which the side and bottom faces are spaced apart and define a maximum opening there between through which material to be handled can pass.

19. The grab of claim 18, in which when the grab moves from the closed position to the fully opened position, a plane through the pivot axis and the side and bottom edges of the grab shell has an angular displacement about the pivot axis that is included in the range of 50-70 degrees.

20. The grab of claim 1, including a set of two hoisting cables that are connected to the hoisting cable connections.

21. The grab of claim 1, including a set of two closing cables that are connected to the closing cable connections.

22. The grab of claim 21, in which the closing cables are interconnected via a connecting piece.

23. A four cable operated scissors grab, comprising a pair of scissor levers that are connected via a pivot joint to pivot about a pivoting axis, which scissor levers each include a grab shell and a hoist cable connection situated on a first side of the lever with respect to the pivot joint, and a closing cable connection situated on a second side of the lever that is opposite with respect to the pivot joint, a dedicated hoisting cable being fastened to each lever on the first side of the lever, and a dedicated closing cable being fastened to each lever at the second side of the lever, wherein the scissor levers each include a sheave on the second side of the lever, and wherein in use each of the two closing cables extends in a single pass from the closing cable connection on the second side of one lever via the closing sheave on the second side of the other lever to depart from the grab and to continue upward to a crane carrying the grab

24. Four cable operated scissors grab, comprising a pair of scissor levers that are pivotably connected via a pivot joint, which scissor levers each include a grab shell and a hoist cable connection situated on a first side of the lever with respect to the pivot joint, and a closing cable connection situated on a second side of the lever that is opposite with respect to the pivot joint, so that in use a dedicated hoisting cable is fastened to each lever on the first side of the lever, and a dedicated closing cable is fastened to each lever at the second side of the lever, in which the scissor levers are arranged to pivot about the pivot axis between a closed position of the grab in which side and bottom edges of the shells are adjacent each other and the shells cooperate to form a bucket that can hold material to be handled, and a fully opened position of the grab in which the side and bottom edges are spaced apart and define a maximum opening there between through which material to be handled can pass, wherein when the grab moves from the closed position to the fully opened open position, a plane through the pivot axis and the side and bottom edges of each grab shell has an angular displacement about the pivot axis that is included in the range of 50-70 degrees.

25. A cable connector with integral cable guide for a grab in accordance with claim 15, comprising a carrier, which in use may be rotatably connected to a grab, including a first portion to which the cable connects that extends from a rotational joint in a first direction, and further includes a second portion that is provided with a cable guide that extends from the rotational joint in a second, opposite direction, and that covers part of the circumference of a sheave of the grab to hold the cable on the circumference of the sheave.
